(19) United States
(12) Patent Application Publication
(10) Pub. No.: US 2018/0171946 A1
(43) Pub. Date: Jun. 21, 2018

(54) ENGINE DEVICE

(71) Applicant: Yanmar Co., Ltd., Osaka-shi, Osaka-fu (JP)

(72) Inventors: Tadayoshi FURUKAWA, Osaka-shi (JP); Seiji YUKISHIGE, Osaka-shi (JP); Hisayasu YAMASE, Osaka-shi (JP); Takeshi SHIMA, Osaka-shi (JP)

(21) Appl. No.: 15/755,471

(22) PCT Filed: Jun. 21, 2016
(86) PCT No.: PCT/JP2016/068414

§ 371 Date: Feb. 26, 2018

(30) Foreign Application Priority Data
Aug. 26, 2015 (JP) 2015-167117
Aug. 26, 2015 (JP) 2015-167118

(51) Int. Cl. F02M 35/10; F16K 49/00; F01M 13/04

(52) U.S. Cl. CPC F02M 35/10268; F16K 49/005; F01M 13/0405; F01M 2013/0477; F02M 35/10236; F01M 2013/0455; F01M 2013/0472; F02M 35/10222

(57) ABSTRACT

An engine device with high reliability and high safety even in use in cold regions, especially in arctic regions at −20° C. or less, the engine device including: a heating portion (21, 22, 23, 24, 25, 26) configured to increase a temperature in a mixed region where an intake air flowing in a blow-by gas mixed joint (20, 20A, 20B, 20C, 20D) and a blow-by gas introduced from a returning hose (12) are mixed; and/or a pressure regulation portion (121, 125) having a blow-by gas passage in which the blow-by gas from a combustion chamber flows.

### TECHNICAL FIELD

The present disclosure relates to an engine device such as a diesel engine that is mounted as a power source in various types of power equipment such as working vehicles, agricultural machines, electric generators, and refrigerators, and particularly to an engine device including a blow-by gas returning mechanism that returns a blow-by gas to an intake system.

### BACKGROUND ART

Exhaust emission regulation to engine devices serving as internal combustion engines has become more and more strict in recent years, and various measures have been proposed for engine devices in order to comply with exhaust emission regulation. As measures against exhaust gas in diesel engines or other machines to date, an exhaust gas recirculation (EGR) device for returning part of exhaust gas to an intake side is provided to reduce a combustion temperature and thereby reduce the amount of nitrogen oxide (NOx) in the exhaust gas. Specifically, the proposed devices include a configuration using an improved exhaust gas purifier for use in a diesel engine (see, for example, Patent Literature 1: PTL 1) and a configuration in which the number of parts of a blow-by gas returning device is reduced in order to simplify a maintenance and inspection work (see, for example, Patent Literature 2: PTL 2), for example. Another proposed technique is that lubricating oil is separated from a blow-by gas that has leaked from a combustion chamber and the blow-by gas from which lubricating oil has been separated is returned to an intake system for recirculation.

### CITATION LIST

### Patent Literature

PTL 1: Japanese Patent Application Laid-Open No. 2013-133796

PTL 2: Japanese Patent Application Laid-Open No. 2013-148010

### SUMMARY OF INVENTION

### Technical Problem

In a configuration that returns a blow-by gas in a crank case that has leaked from a combustion chamber to an intake system, the blow-by gas contains moisture together with an oil component that is a lubricating oil, and thus, there arises a significant problem in use in cold regions, especially in arctic regions at −20° C. or less. In cold regions, especially arctic regions at −20° C. or less, there occurs a phenomenon that a blow-by gas is rapidly cooled in a portion where the blow-by gas is merged with intake air (outdoor air), and moisture contained in the blow-by gas is frozen to generate ice coating on a pipe conduit in which the blow-by gas flows. Consequently, the pipe conduit for the blow-by gas is blocked with ice, and the pressure in the crank case of the engine device increases so that lubricating oil therein leaks out, disadvantageously. In addition, the leakage of lubricating oil might cause a shortage of lubricating oil, resulting in damage of equipment (e.g., supercharger).

An aspect of the present disclosure is intended to solve the problems described above, and has an object of providing an engine device with high reliability and high safety that overcomes, even in use in cold regions, especially in arctic regions at −20° C. or less, problems caused by the blow-by gas having leaked from the combustion chamber and does not allow the lubricating oil in the crank case to leak out therefrom.

### Solution to Problem

According to an aspect of the present disclosure, an engine device having a blow-by gas returning mechanism that returns a blow-by gas having leaked from a combustion chamber to an intake pipe in which intake air flows, includes:
a returning hose in which the blow-by gas from the combustion chamber flows;
a blow-by gas mixed joint configured to introduce the blow-by gas flowing in the returning hose into the intake pipe; and
heating means configured to increase an intake air temperature in a mixed region where intake air flowing in the blow-by gas mixed joint and the blow-by gas introduced from the returning hose are mixed, wherein
the heating means uses, as a heating source, coolant water in the engine device.

According to an aspect of the present disclosure, an engine device having a blow-by gas returning mechanism that returns a blow-by gas having leaked from a combustion chamber to an intake pipe in which intake air flows, includes:
a pressure regulation portion including a blow-by gas passage in which the blow-by gas from the combustion chamber flows;
a returning hose connected to the blow-by gas passage; and
a blow-by gas mixed joint configured to introduce the blow-by gas flowing in the returning hose into the intake pipe, wherein
the pressure regulation portion includes a pressure regulation valve configured to cause the blow-by gas passage to be communicated with outside when a pressure in the blow-by gas passage exceeds a predetermined pressure.

### Advantageous Effects of Invention

According to the present disclosure, it is possible to provide an engine device with high reliability and high safety that overcomes problems caused by a blow-by gas having leaked from a combustion chamber and does not allow lubricating oil in a crank case to leak out therefrom, even in a case where the engine device is used in cold regions, especially in arctic regions at −20° C. or less.

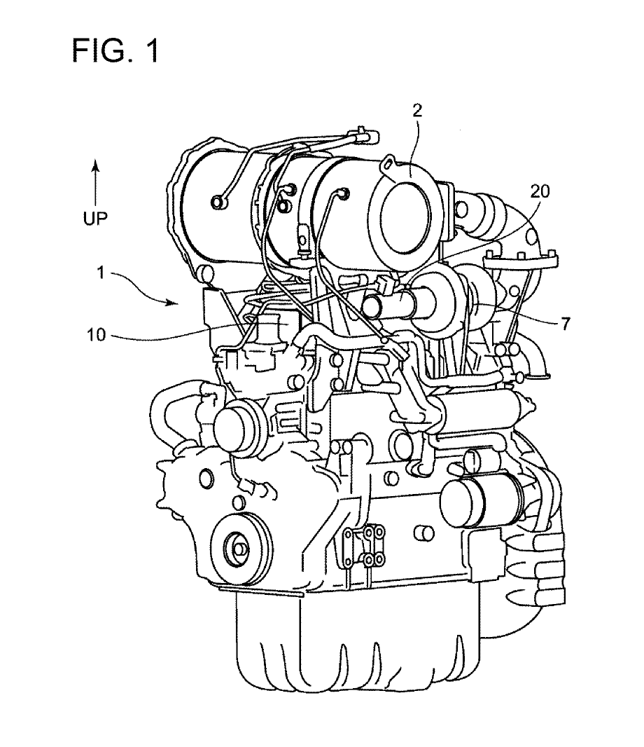

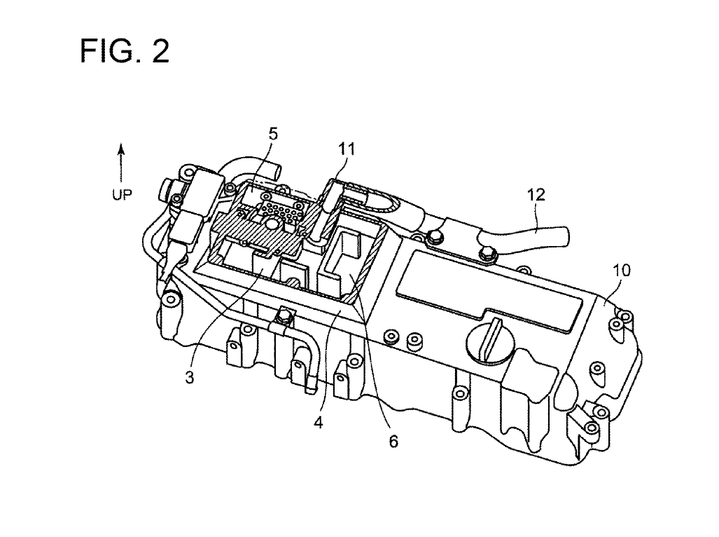

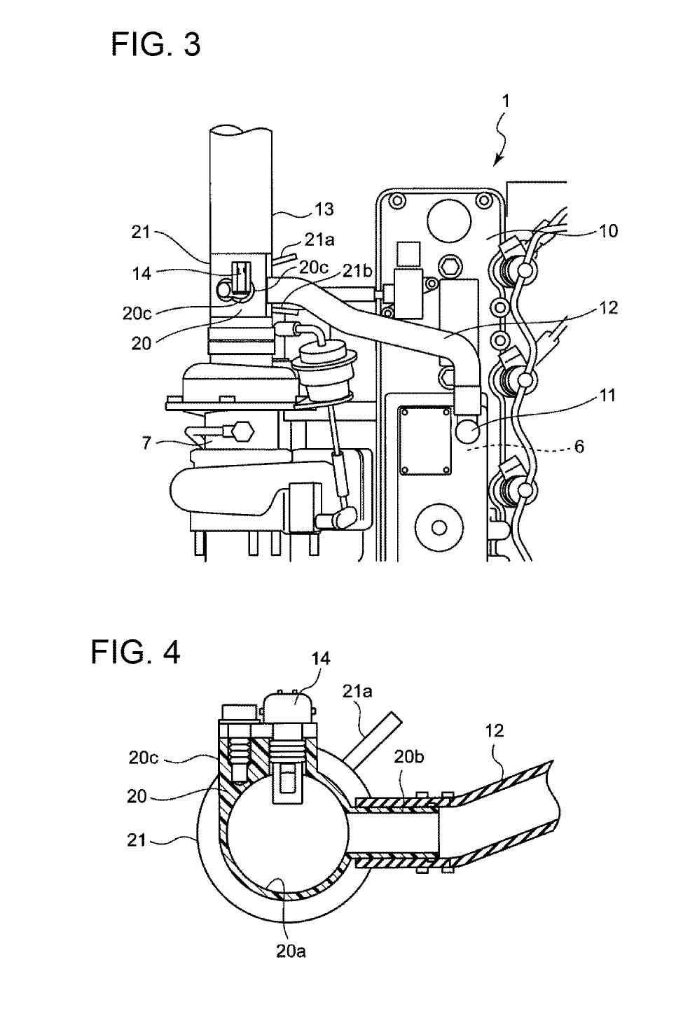

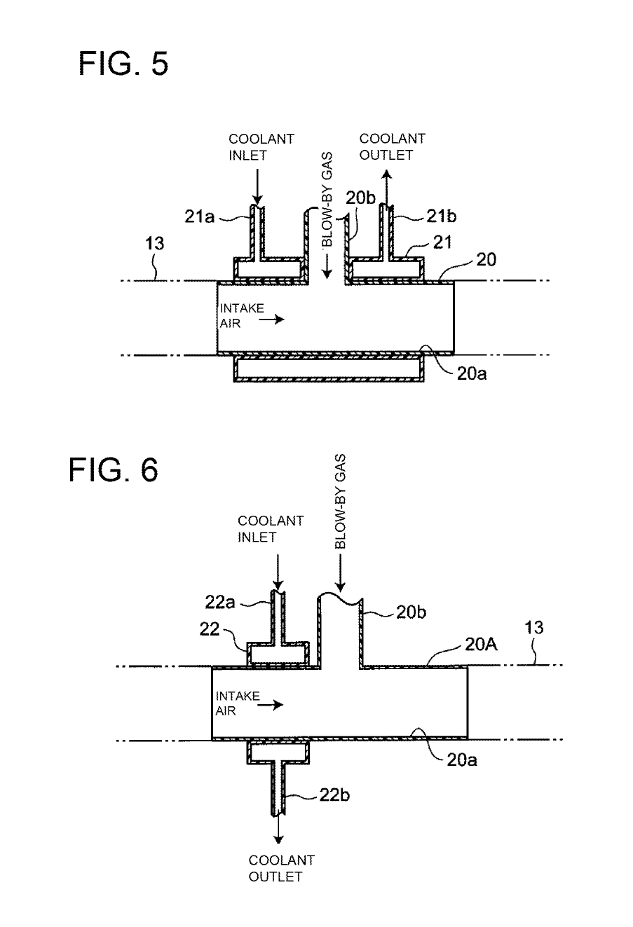

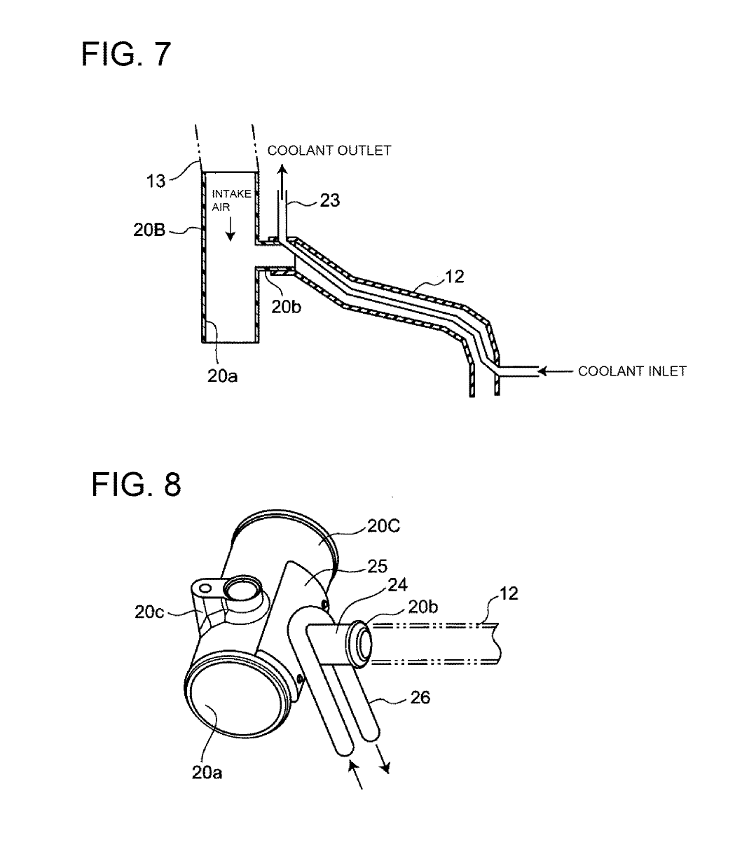

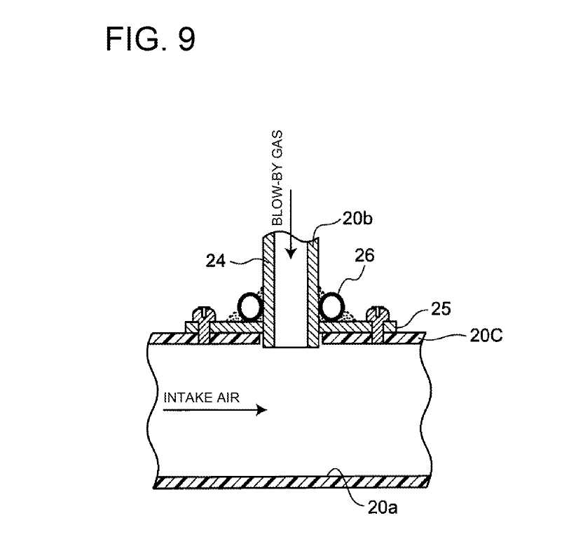

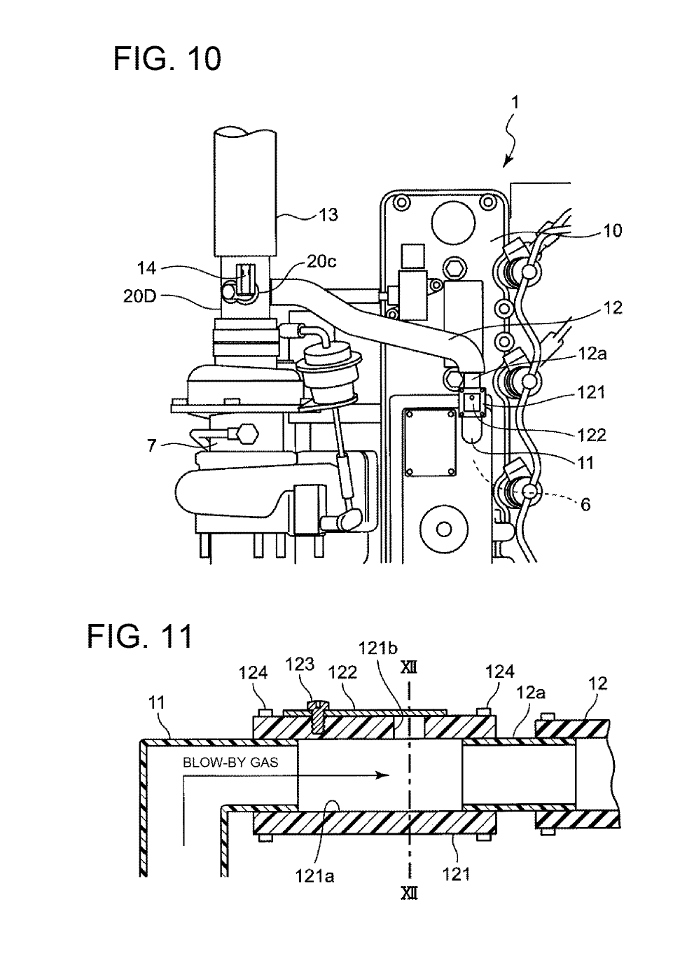

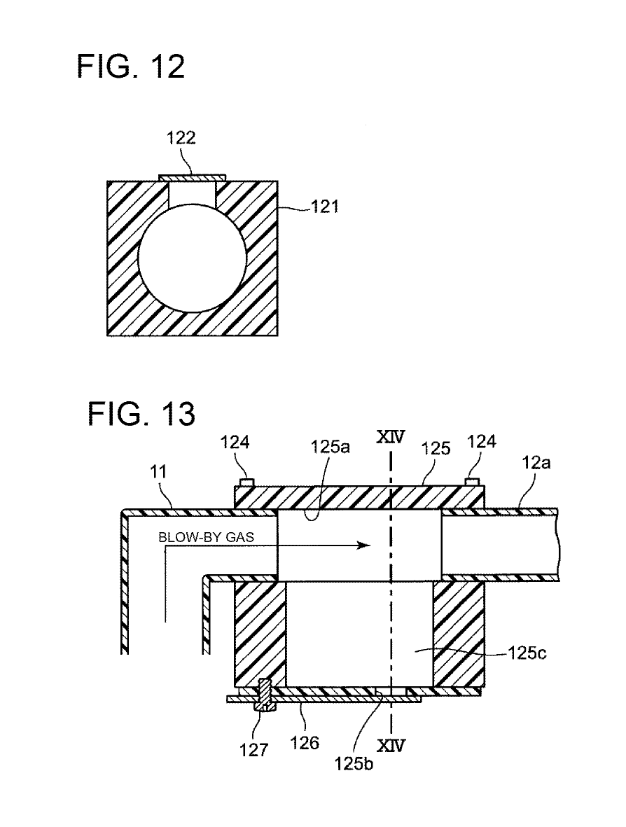

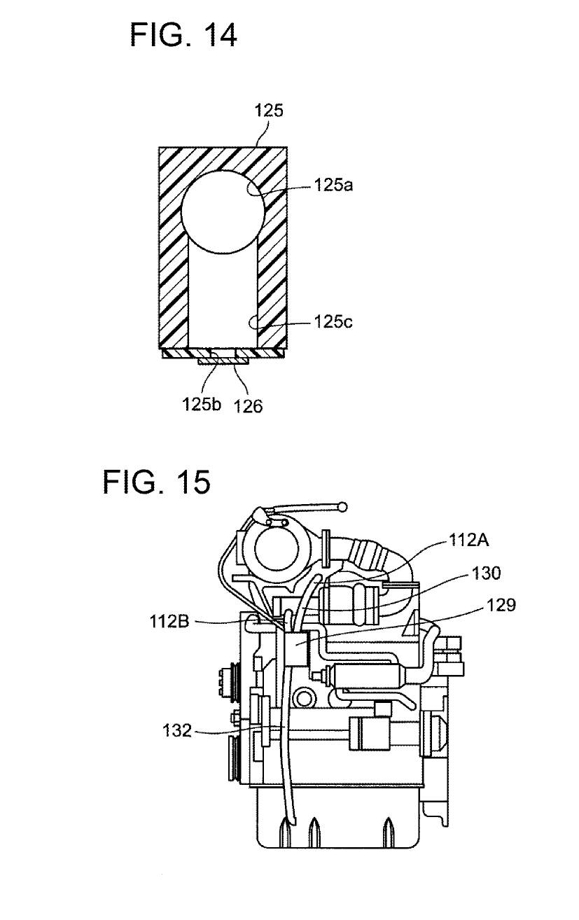

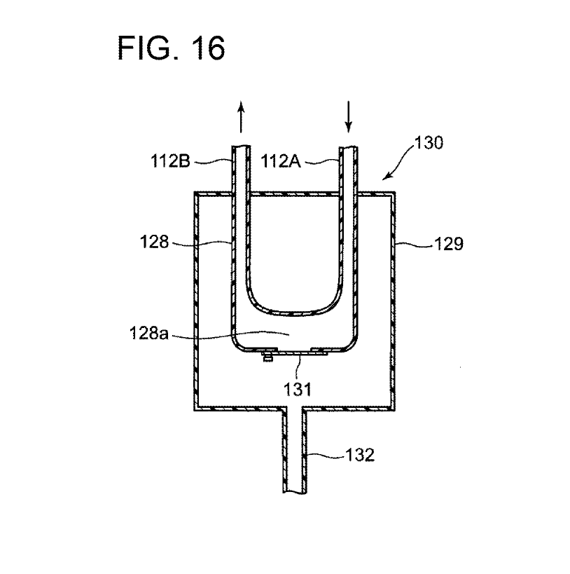

### BRIEF DESCRIPTION OF DRAWINGS

[FIG. 1] A perspective view illustrating a diesel engine according to a first embodiment of the present disclosure.

[FIG. 2] A perspective view illustrating the vicinity of a head cover covering an upper surface of a cylinder head of the diesel engine according to the first embodiment.

[FIG. 3] A plan view illustrating a part of the diesel engine according to the first embodiment including the head cover when viewed from above.

[FIG. 4] A cross-sectional view of a blow-by gas mixed joint in the diesel engine according to the first embodiment taken along a line orthogonal to an airflow direction of intake air.

[FIG. 5] A cross-sectional view of the blow-by gas mixed joint in the diesel engine according to the first embodiment taken along the airflow direction of intake air.

[FIG. 6] A cross-sectional view of a blow-by gas mixed joint in a diesel engine according to a second embodiment of the present disclosure taken along an intake direction.

[FIG. 7] A cross-sectional view illustrating components such as a returning hose in a diesel engine according to a third embodiment of the present disclosure.

[FIG. 8] A perspective view illustrating a blow-by gas mixed joint in a diesel engine according to a fourth embodiment of the present disclosure.

[FIG. 9] A cross-sectional view of the blow-by gas mixed joint shown in FIG. 8 taken along an intake direction.

[FIG. 10] A plan view illustrating a part of a diesel engine according to a fifth embodiment of the present disclosure including a head cover when viewed from above.

[FIG. 11] A cross-sectional view of a pressure regulation portion provided in a returning hose in the diesel engine according to the fifth embodiment taken along a flow direction of a blow-by gas.

[FIG. 12] A cross-sectional view of the pressure regulation portion taken along line XII-XII of FIG. 11.

[FIG. 13] A cross-sectional view of a pressure regulation portion in a diesel engine according to a sixth embodiment of the present disclosure taken along a flow direction of a blow-by gas.

[FIG. 14] A cross-sectional view of the pressure regulation portion taken along line XIV-XIV of FIG. 13.

[FIG. 15] A view schematically illustrating arrangement of a returning hose via which a blow-by gas from an exhaust gas outlet of an engine body to a blow-by gas mixed joint flows in a diesel engine according to a seventh embodiment of the present disclosure.

[FIG. 16] A view schematically illustrating a configuration of the returning hose in the diesel engine according to the seventh embodiment.

### DESCRIPTION OF EMBODIMENTS

According to a first aspect of the present disclosure, an engine device having a blow-by gas returning mechanism that returns a blow-by gas having leaked from a combustion chamber to an intake pipe in which intake air flows, includes:
a returning hose in which the blow-by gas from the combustion chamber flows;
a blow-by gas mixed joint configured to introduce the blow-by gas flowing in the returning hose into the intake pipe; and
a heating portion configured to increase an intake air temperature in a mixed region where intake air flowing in the blow-by gas mixed joint and the blow-by gas introduced from the returning hose are mixed, wherein
the heating portion uses, as a heating source, coolant water in the engine device.

The engine device according to the first aspect of the present disclosure having the configuration described above can be an engine device with high reliability and high safety that can prevent, even in use in cold regions, especially in arctic regions at −20° C. or less, a phenomenon in which a pipe conduit in a mixed region where a blow-by gas having leaked from a combustion chamber and intake air (outdoor air) are mixed is blocked with ice.

In an engine device according to a second aspect of the present disclosure, the heating portion in the first aspect may be configured to allow the coolant water to flow in a part of an outer peripheral surface of the blow-by gas mixed joint, the part corresponding to the mixed region where the intake air flowing in the blow-by gas mixed joint and the blow-by gas introduced from the returning hose are mixed. In the engine device according to the second aspect of the present disclosure having the configuration described above, the mixed region where the intake air flowing in the blow-by gas mixed joint and the blow-by gas introduced from the returning hose are mixed is heated. As a result, it is possible to reduce generation of ice coating on the pipe conduit in the mixed region, and therefore to prevent blockage of the pipe conduit.

In an engine device according to a third aspect of the present disclosure, the heating portion in the first aspect may be configured to allow the coolant water to flow in a part of an outer peripheral surface of the blow-by gas mixed joint, the part being upstream of a region of the blow-by gas mixed joint into which the blow-by gas is introduced from the returning hose. In the engine device according to the third aspect of the present disclosure having the configuration described above, even in use in, e.g., an arctic region, intake air upstream of the region of the blow-by gas mixed joint into which the blow-by gas is introduced from the returning hose is heated. As a result, it is possible to reduce generation of ice coating on the pipe conduit in the mixed region, and therefore to prevent blockage of the pipe conduit.

In an engine device according to a fourth aspect of the present disclosure, the heating portion in the first aspect may be configured to allow the coolant water to flow in parts of an outer peripheral surface of the blow-by gas mixed joint, the parts being upstream and downstream of a region of the blow-by gas mixed joint into which the blow-by gas is introduced from the returning hose. In the engine device according to the fourth aspect of the present disclosure having the configuration described above, even in use in, e.g., an arctic region, intake air upstream and downstream of the region of the blow-by gas mixed joint into which the blow-by gas is introduced from the returning hose is heated. As a result, it is possible to reduce generation of ice coating on the pipe conduit in the mixed region, and therefore to prevent blockage of the pipe conduit.

In an engine device according to a fifth aspect of the present disclosure, the heating portion in the first aspect may be a coolant water pipe conduit disposed such that the blow-by gas flowing in the returning hose is heated by the coolant water. In the engine device according to the fifth aspect of the present disclosure having the configuration described above, even in use in, e.g., an arctic region, the blow-by gas introduced from the returning hose into the blow-by gas mixed joint is heated. As a result, it is possible to reduce generation of ice coating on the pipe conduit in the mixed region, and therefore to prevent blockage of the pipe conduit.

In an engine device according to a sixth aspect of the present disclosure, the heating portion in the first aspect may be a coolant water pipe conduit disposed upstream of a region of the blow-by gas mixed joint into which the blow-by gas is introduced. In the engine device according to the sixth aspect of the present disclosure having the configuration described above, even in use in, e.g., an arctic region, intake air upstream of the region of the blow-by gas mixed joint into which the blow-by gas is introduced is heated. As a result, it is possible to reduce generation of ice coating on the pipe conduit in the mixed region, and therefore to prevent blockage of the pipe conduit.

An engine device according to a seventh aspect of the present disclosure may be configured such that
the heating portion in the first aspect is made of a member being provided in at least a part of the blow-by gas mixed joint and having heat conductivity, and
the heating portion includes
   a blow-by gas introduction pipe to which the returning hose is connected,
   a spacer to which the blow-by gas introduction pipe is adhered in a heat-conductive manner and which is in close contact with an outer peripheral surface of the blow-by gas mixed joint in a heat-conductive manner, and
   a coolant water pipe that is disposed in close contact with the blow-by gas introduction pipe and the spacer in a heat-conductive manner and is configured to allow the coolant water to flow in the coolant water pipe. In the engine device according to the seventh aspect of the present disclosure having the configuration described above, even in use in, e.g., an arctic region, the mixed region of the blow-by gas mixed joint in which the blow-by gas is introduced is heated. As a result, it is possible to reduce generation of ice coating on the pipe conduit in the mixed region, and therefore to prevent blockage of the pipe conduit.

According to an eighth aspect of the present disclosure, an engine device having a blow-by gas returning mechanism that returns a blow-by gas having leaked from a combustion chamber to an intake pipe in which intake air flows, includes:
a pressure regulation portion including a blow-by gas passage in which the blow-by gas from the combustion chamber flows;
a returning hose connected to the blow-by gas passage; and
a blow-by gas mixed joint configured to introduce the blow-by gas flowing in the returning hose into the intake pipe, wherein
the pressure regulation portion includes a pressure regulation valve configured to cause the blow-by gas passage to be communicated with outside when a pressure in the blow-by gas passage exceeds a predetermined pressure.

In the engine device according to the eighth aspect of the present disclosure having the configuration described above, even in use in cold regions, especially in arctic regions at −20° C. or less, the pressure in the engine body is maintained at a desired pressure, even if ice coating is generated on a pipe conduit for a blow-by gas having leaked from the combustion chamber, especially on a pipe conduit near the mixed region where intake air (outdoor air: fresh air) is merged with the blow-by gas, and thus the pipe conduit is blocked with ice.

In an engine device according to a ninth aspect of the present disclosure, the pressure regulation portion in the eighth aspect may be configured to include an accumulation portion under the blow-by gas passage, and the accumulation portion is configured such that liquid contained in the blow-by gas flowing through the blow-by gas passage is accumulated in the accumulation portion. In the engine device according to the ninth aspect of the present disclosure having the configuration described above, the liquid such as moisture and/or an oil component contained in the blow-by gas introduced from the engine body into the blow-by gas mixed joint is removed in the blow-by gas passage. As a result, even in use in, e.g., an arctic region, it is possible to reduce generation of ice coating on the pipe conduit in the mixed region where the intake air and the blow-by gas are mixed in the blow-by gas mixed joint, and to remove an unnecessary oil component.

In an engine device according to a tenth aspect of the present disclosure, the pressure regulation valve in the ninth aspect may be configured to open an opening in a bottom surface of the accumulation portion under the weight of the liquid accumulated in the accumulation portion. In the engine device according to the tenth aspect of the present disclosure having the configuration described above, the liquid such as water and/or lubricating oil that has been removed in the blow-by gas passage can be automatically transferred to the other region. This facilitates maintenance management.

In an engine device according to an eleventh aspect of the present disclosure, the returning hose in the eighth aspect may be connected to the blow-by gas mixed joint such that the blow-by gas is introduced from below. In the engine device according to the eleventh aspect of the present disclosure having the configuration described above, it is possible to accumulate the liquid such as moisture and/or an oil component contained in the blow-by gas introduced from the engine body into the blow-by gas mixed joint.

In an engine device according to a twelfth aspect of the present disclosure, the pressure regulation portion in the eleventh aspect may be configured to be located in an undermost position of a path via which the blow-by gas is caused to flow from the combustion chamber to the blow-by gas mixed joint so that liquid contained in the blow-by gas is discharged. In the engine device according to the twelfth aspect of the present disclosure having the configuration described above, it is possible to remove, by a simple configuration, the liquid such as moisture and/or an oil component contained in the blow-by gas introduced from the engine body into the blow-by gas mixed joint.

Embodiments of the present disclosure will be described hereinafter with reference to the accompanying drawings. Note that the configuration of the present invention is not limited to the following embodiments. An engine device according to an aspect of the present disclosure will be described using a diesel engine as an example in the following embodiments. The present disclosure, however, is not limited to a configuration of the diesel engine according to the embodiments, and includes an engine device configured based on a technical idea equivalent to a technical idea described in the embodiments.

### First Embodiment

A diesel engine serving as an engine device according to a first embodiment of the present disclosure will be described with reference to the accompanying drawings. In the drawings, the direction indicated by arrow UP is an upward direction.

FIG. 1 is a perspective view illustrating an entire configuration of a diesel engine 1 according to the first embodiment of the present disclosure. FIG. 2 is a perspective view illustrating the vicinity of a head cover covering an upper surface of a cylinder head in the diesel engine 1 according to the first embodiment, and partially shows the vicinity in cross section. The diesel engine 1 according to the first embodiment includes a continuous regeneration type exhaust gas purifier 2.

The diesel engine 1 according to the first embodiment includes a blow-by gas returning mechanism 3 (see FIG. 2) for returning a blow-by gas in a crank case that has leaked from a combustion chamber to an intake system (intake pipe). A head cover 10 covering, for example, an intake valve and an exhaust valve provided on the upper surface of the cylinder head of the diesel engine 1 has the blow-by gas returning mechanism 3. The blow-by gas returning mechanism 3 includes a gas pressure regulation portion 4 formed by expanding a part of the upper surface of the head cover 10 upward. In the gas pressure regulation portion 4, a blow-by gas intake chamber 5 in which a blow-by gas that has leaked from, for example, the combustion chamber of the diesel engine 1 is taken, and a blow-by gas expansion chamber 6 to which the blow-by gas in the blow-by gas intake chamber 5 is supplied through a gas pressure regulation valve are formed. The bottom surface of the blow-by gas expansion chamber 6 is provided with a check valve such as a plate spring that bends downward under the weight. When a lubricating oil component is accumulated in the blow-by gas expansion chamber 6, the check valve rotates under the weight of the lubricating oil component and causes the lubricating oil component to be dropped onto the upper surface of the cylinder head. In the configuration as described above, the lubricating oil component accumulated in the blow-by gas expansion chamber 6 falls on the upper surface of the cylinder head, and is collected in the diesel engine.

In the configuration of the first embodiment, since the bottom surface of the blow-by gas expansion chamber 6 is provided with the check valve that is the plate spring, even when lubricating oil is spattered from the upper surface of the cylinder head toward the check valve, the spattered lubricating oil is not mixed in the blow-by gas expansion chamber 6.

The blow-by gas expansion chamber 6 includes a plurality of maze conduits defined by a plurality of partition plates, for example. The blow-by gas expansion chamber 6 has a configuration in which when a blow-by gas expands in the maze conduits, a lubricating oil component in the blow-by gas is thereby removed. The removed lubricating oil component is accumulated on the bottom surface of the blow-by gas expansion chamber 6, and under the weight of the accumulated lubricating oil component, for example, the plate spring bends so that the lubricating oil component is dropped onto the upper surface of the cylinder head and is collected in the diesel engine.

On the other hand, the blow-by gas from which the lubricating oil component has been removed in the blow-by gas expansion chamber 6 is sent to a pipe conduit of an intake pipe 13 (see FIG. 3 described later) through a pipe conduit of a returning hose 12 (see FIG. 2) connected to an exhaust gas outlet 11 of the blow-by gas expansion chamber 6. The exhaust gas outlet 11 of the blow-by gas expansion chamber 6 is integrally formed with the head cover 10 and projects from the upper surface of the head cover 10.

FIG. 3 is a plan view illustrating a part of the diesel engine 1 according to the first embodiment including the head cover 10 when viewed from above. FIG. 3 illustrates a state in which the exhaust gas outlet 11 of the blow-by gas expansion chamber 6 provided in the head cover 10 and the intake pipe 13 are connected together by the returning hose 12.

The intake pipe 13 illustrated in FIG. 3 is an intake pipe conduit in which intake air (outdoor air: fresh air) flows toward a supercharger (turbocharger) 7 through an air cleaner (not shown). In the intake pipe 13 illustrated in FIG. 3, intake air flows from the top to the bottom. The pipe conduit of the intake pipe 13 is provided with a blow-by gas mixed joint 20 configured to introduce a blow-by gas from the blow-by gas expansion chamber 6 in the head cover 10 into the intake pipe 13. The returning hose 12 connecting the blow-by gas mixed joint 20 connected to the intake pipe 13 and the exhaust gas outlet 11 of the blow-by gas expansion chamber 6 to each other is made of a flexible material having heat resistance and cold resistance, such as a rubber material.

FIG. 4 is a cross-sectional view of the blow-by gas mixed joint 20 taken along a line orthogonal to an airflow direction of intake air. FIG. 4 illustrates a cross section including the center of a blow-by gas inlet 20b (described later) to which the returning hose 12 having a circular cross section is joined. FIG. 5 is a cross-sectional view of the blow-by gas mixed joint 20 taken along the airflow direction of intake air (intake direction).

As illustrated in FIGS. 4 and 5, the blow-by gas mixed joint 20 has a three-way joint structure and is configured such that the blow-by gas inlet 20b is provided in an intake passage 20a communicating with the pipe conduit of the intake pipe 13. The blow-by gas inlet 20b is connected to one end of the returning hose 12.

In the diesel engine 1 according to the first embodiment, the blow-by gas mixed joint 20 is provided with a temperature sensor 14 (see FIG. 3) that detects an intake air temperature in the intake passage 20a. The temperature sensor 14 is inserted in the direction orthogonal to the intake direction of the intake passage 20a, and is held by a sensor holding part 20c (see FIG. 4) extending outward from the outer peripheral surface of the intake passage 20a. In the configuration of the first embodiment, a holding plate (not shown) provided with the temperature sensor 14 is screwed to the sensor holding part 20c so as to securely hold the temperature sensor 14 on the sensor holding part 20c.

In the configuration of the first embodiment, the temperature detection region of the temperature sensor 14 includes a plane orthogonal to the intake direction including a center line extending in the introduction direction of the blow-by gas inlet 20b. That is, the temperature sensor 14 is disposed near the blow-by gas inlet 20b of the blow-by gas mixed joint 20 to detect a temperature near the blow-by gas inlet 20b.

In the example of the first embodiment, the temperature sensor 14 is disposed near the blow-by gas inlet 20b as described above. Alternatively, the temperature sensor 14 may be disposed at a position offset upstream and/or downstream of the blow-by gas inlet 20b in the intake direction so that the temperature sensor 14 detects an intake air temperature before and/or after the introduction of a blow-by gas. In the configuration of the first embodiment, the introduction direction of the blow-by gas inlet 20b is orthogonal to the direction of disposing the temperature sensor 14 (insertion direction in the blow-by gas mixed joint 20: top-and-bottom direction in FIG. 4). This configuration can also be changed as appropriate depending on arrangement of parts in the diesel engine 1.

In the diesel engine 1 according to the first embodiment, as illustrated in FIGS. 4 and 5, a heating portion 21 that is heating means is provided near the extended part of the blow-by gas inlet 20b in the blow-by gas mixed joint 20. The heating portion 21 is disposed in the recirculation path of engine coolant water, and is provided with a coolant water inlet 21a through which engine coolant water is supplied and a coolant water outlet 21b through which the engine coolant water having been used to heat the blow-by gas mixed joint 20 is discharged. The heating portion 21 is disposed in close contact with the outer peripheral surface of the blow-by gas mixed joint 20, and serves as the heating means for heating, by allowing engine coolant water at, e.g., approximately 70° C. to flow inside the heating portion 21, a mixed region where intake air flowing in the intake passage 20a of the blow-by gas mixed joint 20 and a blow-by gas supplied from the blow-by gas inlet 20b are mixed. The heating portion 21 is made of a heat-resistant resin material, and may be integrally formed with the blow-by gas mixed joint 20 made of a resin material.

In the cross-sectional view in FIG. 5, the blow-by gas inlet 20b of the blow-by gas mixed joint 20, the coolant water inlet 21a of the heating portion 21, and the coolant water outlet 21b of the heating portion 21 are illustrated in the same cross section for ease of explanation. However, actual arrangement of these elements can be changed as appropriate depending on arrangement of parts in the diesel engine 1.

In a case where an apparatus including, as a power source, a diesel engine 1 serving as an engine device is used in an arctic region (e.g., at an outdoor temperature of −20° C.), the intake air temperature (fresh air temperature) is, for example, −20° C. Simply mixing intake air at such an intake air temperature with a blow-by gas in the crank case that has leaked from the combustion chamber leads to a serious problem that moisture contained in the blow-by gas is instantaneously frozen to generate ice coating on a pipe conduit in a mixed region where the intake air and the blow-by gas are mixed and to block the pipe conduit.

The following will study a case where an apparatus including, as a power source, the diesel engine 1 that is the engine device according to the first embodiment configured as above is used in an arctic region. In the configuration of the diesel engine 1 according to the first embodiment, for example, in a case where outside air at −20° C. is supplied to the intake pipe 13 through the air cleaner, the intake passage 20a of the blow-by gas mixed joint 20 is heated by the heating portion 21 provided on the outer peripheral surface of the blow-by gas mixed joint 20 so that the intake passage 20a attains a temperature of 0° C. or higher. That is, the vicinity of the part in which the intake passage 20a and the blow-by gas inlet 20b of the blow-by gas mixed joint 20 are jointed together, i.e., the mixed region where the intake air and the blow-by gas are mixed is heated by the engine coolant water (e.g., at approximately 70° C.) flowing in the heating portion 21. Therefore, even when a blow-by gas is introduced into the intake passage 20a from the blow-by gas inlet 20b, moisture contained in the blow-by gas is not rapidly cooled by intake air in the intake passage 20a, and thus ice coating is not generated on the wall of a pipe conduit of the intake passage 20a near the blow-by gas inlet 20b.

As described above, even in the case where the apparatus including, as the power source, the diesel engine 1 according to the first embodiment is used in an arctic region, the heating portion 21 that is the heating means is provided in close contact with the outer peripheral surface of the blow-by gas mixed joint 20 so that heat of the engine coolant water is conducted to the blow-by gas mixed joint 20. Consequently, near the blow-by gas inlet 20b of the blow-by gas mixed joint 20 and/or in the intake passage 20a, moisture contained in the blow-by gas is not instantly frozen and ice coating is not generated on the wall of the pipe conduit and thus the pipe conduit is not blocked.

In the configuration of the first embodiment described above, the heating portion 21 is provided to the pipe conduit of the pipeline in which engine coolant water flows. Alternatively, in the present disclosure, coolant water may be caused to flow to the heating portion 21 via a coolant water pipeline for an EGR cooler or a pipeline of an oil cooler. In addition, coolant water may be taken from the diesel engine 1 that is the engine device in such a manner that the coolant water is introduced via an outlet for a coolant water pump. These methods, such as the method of taking the coolant water, are applicable also to configurations of embodiments that will be described later.

As described above, according to the diesel engine 1 of the first embodiment, it is possible to provide an engine device with high reliability and high safety that overcomes problems caused by a blow-by gas having leaked from a combustion chamber and does not allow lubricating oil in a crank case to leak out therefrom, even in a case where the engine device is used in cold regions, especially in arctic regions at −20° C. or less. According to the diesel engine 1 of the first embodiment of the present disclosure, it is possible to provide an engine device with high reliability and high safety in which a pipe conduit for a blow-by gas having leaked from a combustion chamber, especially a portion where the blow-by gas is merged with intake air, is not blocked with ice, even in use in cold regions, especially in arctic regions at −20° C. or less.

### Second Embodiment

Next, a diesel engine serving as an engine device according to a second embodiment of the present disclosure will be described mainly with respect to aspects different from the first embodiment described above. The diesel engine of the second embodiment is different from that of the first embodiment in the configuration of the heating portion, which is the heating means provided in the blow-by gas mixed joint, and the other part of the configuration is the same as that of the first embodiment. Thus, in the description of the second embodiment, components having the same functions, configurations, and advantages as those in the first embodiment are denoted by the same reference characters, and detailed description thereof will not be repeated.

FIG. 6 is a cross-sectional view of a blow-by gas mixed joint 20A in a diesel engine 1 according to the second embodiment of the present disclosure taken along an intake direction. As illustrated in FIG. 6, according to the second embodiment, a heating portion 22 that is the heating means is provided in close contact with a part of the outer peripheral surface of an intake passage 20a, which part is upstream of a blow-by gas inlet 20b of the blow-by gas mixed joint 20A, so that heat of the heating portion 22 is conducted to the intake passage 20a. The heating portion 22 is provided with a coolant water inlet 22a and a coolant water outlet 22b, which are disposed in the passage of the recirculation path of engine coolant water.

As described above, in the configuration of the second embodiment, the heating portion 22 is provided on the part of the outer peripheral surface of the intake passage 20a, which part is upstream of the blow-by gas inlet 20b. Thus, for example, even in a case where the engine device of the second embodiment is used as a power source in an arctic region (e.g., at an outdoor temperature of −20° C.), intake air (fresh air) flowing in a part of the intake passage 20a, which part is upstream of the blow-by gas inlet 20b of the blow-by gas mixed joint 20A, is heated to a temperature of 0° C. or higher by engine coolant water (e.g., at approximately 70° C.) flowing in the heating portion 22. Consequently, moisture in a blow-by gas introduced from the blow-by gas inlet 20b of the blow-by gas mixed joint 20A is not instantly frozen. As a result, in a mixed region where a blow-by gas from the blow-by gas inlet 20b is introduced into the intake passage 20a, a trouble can be prevented that ice coating is generated on the wall of a pipe conduit in which the blow-by gas flows and the pipe conduit is blocked with ice.

In the example of the configuration of the second embodiment described above, the heating portion 22 is disposed on the part of the outer peripheral surface of the intake passage 20a, which part is upstream of the blow-by gas inlet 20b. Alternatively, the heating portion 22 that is the heating means may be disposed in close contact with the outer peripheral surface of a returning hose 12 connected to the blow-by gas inlet 20b so that heat of the heating portion 22 is conducted to the returning hose 12.

As described above, according to the diesel engine 1 of the second embodiment of the present disclosure, it is possible to provide an engine device with high reliability and high safety in which a pipe conduit for a blow-by gas having leaked from a combustion chamber, especially a portion where the blow-by gas is merged with intake air, is not blocked with ice, even in use in cold regions, especially in arctic regions at −20° C. or less.

### Third Embodiment

Next, a diesel engine serving as an engine device according to a third embodiment of the present disclosure will be described mainly with respect to aspects different from the first embodiment described above. The diesel engine of the third embodiment is different from that of the first embodiment in the configuration of the heating means provided in, e.g., the returning hose that projects from the top surface of the head cover and serves as the pipe conduit from the exhaust gas outlet to the blow-by gas inlet of the blow-by gas mixed joint. The other part of the configuration of the engine device according to the third embodiment is the same as that of the first embodiment. Thus, in the description of the third embodiment, components having the same functions, configurations, and advantages as those in the first embodiment are denoted by the same reference characters, and detailed description thereof will not be repeated.

FIG. 7 is a cross-sectional view of a returning hose 12 connecting an exhaust gas outlet 11 in a head cover 10 and a blow-by gas inlet 20b of a blow-by gas mixed joint 20B to each other in a diesel engine 1 according to the third embodiment of the present disclosure. As illustrated in FIG. 7, a coolant water pipe conduit 23 is disposed inside the returning hose 12. The coolant water pipe conduit 23 is a pipeline in which engine coolant water that is coolant water having been used to cool the engine flows, and is provided over a substantially entire length of the returning hose 12. The coolant water pipe conduit 23, which is heating means disposed inside of the returning hose 12, is provided to extend at least to the vicinity of the blow-by gas inlet 20b of the blow-by gas mixed joint 20B.

In the configuration of the third embodiment, the coolant water pipe conduit 23, which is the heating means, is connected to a pipe conduit in which engine coolant water that is coolant water having been used to cool the engine flows. Alternatively, in the present disclosure, as well as in the configurations of the other embodiments, a coolant water pipe conduit 23 that is a coolant water pipeline for an EGR cooler or a pipeline for an oil cooler may be disposed inside of the returning hose 12.

In the example illustrated in FIG. 7, the coolant water pipe conduit 23 is disposed inside the returning hose 12. Alternatively, the coolant water pipe conduit 23 may be disposed in close contact with the outer peripheral surface of the returning hose 12, for example, in a linear form along a flow of coolant water or in a serpentine form. Further alternatively, the coolant water pipe conduit 23 may be spirally wound around the outer peripheral surface of the returning hose.

As described above, in the configuration of the third embodiment, the coolant water pipe conduit 23 in which coolant water flows is provided in the returning hose 12. Thus, for example, even in a case where the engine device of the third embodiment is used as a power source in arctic regions (e.g., at an outdoor temperature of −20° C.), a blow-by gas flowing inside the thin returning hose 12 from the exhaust gas outlet 11 in the head cover 10 of the diesel engine 1 to the blow-by gas inlet 20b of the blow-by gas mixed joint 20B is heated to a temperature of 0° C. or higher by engine coolant water (e.g., at approximately 70° C.) flowing in the coolant water pipe conduit 23. As a result, moisture in the blow-by gas inside the returning hose 12 is not instantly frozen. Thus, in each of the returning hose 12, the blow-by gas inlet 20b, and a mixed region for the blow-by gas inlet 20b and the intake passage 20a, a trouble can be prevented that ice coating is generated on the wall of the pipe conduit and the pipe conduit is blocked with ice.

The coolant water pipe conduit 23, in which coolant water flows and which serves as the heating means, may be disposed upstream of a region of the blow-by gas mixed joint 20B into which a blow-by gas is introduced. In this configuration, it is possible to heat intake air upstream of the region into which the blow-by gas is introduced and thus to increase an intake air temperature in a mixed region where the intake air flowing in the blow-by gas mixed joint 20B and the blow-by gas introduced from the returning hose 12 are mixed, thereby yielding advantages similar to those of the above-described configuration in which the coolant water pipe conduit 23 is disposed in the returning hose 12.

As described above, with the diesel engine 1 according to the third embodiment of the present disclosure, it is possible to provide an engine device with high reliability and high safety in which a pipe conduit for a blow-by gas having leaked from a combustion chamber, especially a portion where the blow-by gas is merged with intake air, is not blocked with ice, even in use in cold regions, especially in arctic regions at −20° C. or less.

### Fourth Embodiment

Next, a diesel engine serving as an engine device according to a fourth embodiment of the present disclosure will be described mainly with respect to aspects different from the first embodiment described above. The diesel engine of the fourth embodiment is different from that of the first embodiment in the configuration of the blow-by gas mixed joint. The other part of the configuration of the engine device according to the fourth embodiment is the same as that of the first embodiment. Thus, in the description of the fourth embodiment, components having the same functions, configurations, and advantages as those in the first embodiment are denoted by the same reference characters, and detailed description thereof will not be repeated.

FIG. 8 is a perspective view illustrating a blow-by gas mixed joint 20C in a diesel engine 1 according to the fourth embodiment of the present disclosure. FIG. 9 is a cross-sectional view of the blow-by gas mixed joint 20C shown in FIG. 8 taken along an intake direction.

Similarly to the configurations of the first to third embodiments described above, the blow-by gas mixed joint 20C in the diesel engine 1 of the fourth embodiment is disposed in a pipe conduit of an intake pipe 13 so as to introduce, into the intake pipe 13, a blow-by gas in a head cover having leaked from a combustion chamber. As illustrated in FIGS. 8 and 9, the blow-by gas mixed joint 20C connected to the intake pipe 13 is provided with a blow-by gas introduction pipe 24 to which a returning hose 12 is connected. In addition, the blow-by gas mixed joint 20C is provided with a spacer 25 configured to fix the blow-by gas introduction pipe 24 to the blow-by gas mixed joint 20C. Furthermore, a coolant water pipe 26 in which engine coolant water having been used to cool the engine flows is in contact with and adhered to the blow-by gas introduction pipe 24 and the spacer 25. The blow-by gas introduction pipe 24, the spacer 25, and the coolant water pipe 26 are each made of a metal having good heat conductivity, e.g., copper, aluminum, or brass, and are adhered to each other by, e.g., welding so that good heat conductivity is maintained therebetween.

In the configuration of the fourth embodiment, an intake passage 20a of the blow-by gas mixed joint 20C is made of a resin material having heat resistance. Thus, the spacer 25 is in close contact with the pipe wall of the intake passage 20a in a liquid-proof manner and is fixed thereto with a bolt. There is a predetermined contact area interposed between the pipe wall of the intake passage 20a and the spacer 25 so that heat is conducted therebetween.

As described above, in the configuration of the fourth embodiment, the coolant water pipe 26 in which coolant water from the engine flows is provided to conduct heat to the blow-by gas introduction pipe 24 connected with the returning hose 12 and to the spacer 25 that is in contact with the pipe wall of the intake passage 20a. Thus, for example, in a case where the engine device of the fourth embodiment is used as a power source in arctic regions (e.g., at an outdoor temperature of −20° C.), a mixed region of the blow-by gas mixed joint 20C where a blow-by gas containing moisture and intake air are mixed is heated to a temperature of 0° C. or higher by engine coolant water (e.g., at approximately 70° C.) flowing in the coolant water pipe 26. As a result, moisture contained in the blow-by gas is not instantly frozen in the mixed region where the blow-by gas and the intake air are mixed. Thus, a trouble can be prevented that ice coating is generated on the wall of a pipe conduit in the mixed region and the pipe conduit is blocked with ice.

As described above, according to the diesel engine 1 of the fourth embodiment of the present disclosure, it is possible to provide an engine device with high reliability and high safety in which a pipe conduit for a blow-by gas having leaked from a combustion chamber, especially a portion where the blow-by gas is merged with intake air is not blocked with ice, even in use in cold regions, especially in arctic regions at −20° C. or less.

### Fifth Embodiment

Next, a diesel engine serving as an engine device according to a fifth embodiment of the present disclosure will be described mainly with respect to aspects different from the first embodiment described above. The diesel engine of the fifth embodiment is different from that of the first embodiment in that the diesel engine of the fifth embodiment includes a pressure regulation portion serving as pressure regulation means provided in a returning hose. In the configuration of the diesel engine of the first embodiment, the heating portion 21 that is the heating means is provided in the blow-by gas mixed joint. In a configuration of the diesel engine of the fifth embodiment, the pressure regulation means may be provided instead of the heating means. The other part of the configuration of the diesel engine according to the fifth embodiment is the same as that of the first embodiment. In the description of the fifth embodiment, components having the same functions, configurations, and advantages as those in the first embodiment are denoted by the same reference characters, and detailed description thereof will not be repeated.

An entire configuration of a diesel engine 1 according to the fifth embodiment of the present disclosure is the configuration illustrated in the perspective view of FIG. 1 explained above. A head cover covering the top surface of a cylinder head in the diesel engine 1 of the fifth embodiment has the same configuration as that illustrated in the perspective view of FIG. 2 explained above, and provides the same advantages and effects. The diesel engine 1 according to the fifth embodiment includes a continuous regeneration type exhaust gas purifier 2, in the same manner as the above-described embodiments.

FIG. 10 is a plan view illustrating a part of the diesel engine 1 according to the fifth embodiment including a head cover 10 when viewed from above. FIG. 10 illustrates a state in which an exhaust gas outlet 11 of a blow-by gas expansion chamber 6 provided in the head cover 10 and an intake pipe 13 are connected to each other by a returning hose 12.

Similarly to the configuration of the first embodiment illustrated in FIG. 3 described above, the intake pipe 13 illustrated in FIG. 10 is an intake pipe conduit in which intake air (outdoor air: fresh air) flows toward a supercharger (turbocharger) 7 through an air cleaner (not shown). In the intake pipe 13 illustrated in FIG. 10, intake air flows from the top to the bottom. The pipe conduit of the intake pipe 13 is provided with a blow-by gas mixed joint 20D configured to introduce a blow-by gas from the blow-by gas expansion chamber 6 in the head cover 10 into the intake pipe 13. The returning hose 12 connecting the blow-by gas mixed joint 20D connected to the intake pipe 13 and the exhaust gas outlet 11 (an outlet of a valve arm chamber) of the diesel engine body to each other via a pressure regulation portion 121 (described later) is made of a flexible material having heat resistance and cold resistance, such as a rubber material.

FIG. 11 is a cross-sectional view of the pressure regulation portion 121 provided in the returning hose 12 connecting the exhaust gas outlet 11 of the engine body and the blow-by gas mixed joint 20D to each other, taken along a flow direction of a blow-by gas. FIG. 12 is a cross-sectional view of the pressure regulation portion 121 taken along line XII-XII in FIG. 11.

As illustrated in FIGS. 11 and 12, the pressure regulation portion 121 has a blow-by gas passage 121a that is a pipe conduit via which a blow-by gas discharged from the exhaust gas outlet 11 (the outlet of the valve arm chamber) is caused to flow to the returning hose 12. That is, one end of the blow-by gas passage 121a included in the pressure regulation portion 121 is connected to the exhaust gas outlet 11, and the other end of the blow-by gas passage 121a is connected to a returning hose joint 12a provided in one end of the returning hose 12. In the configuration of the fifth embodiment, the pressure regulation portion 121 is jointed to each of the exhaust gas outlet 11 of the engine body and an end of the returning hose joint 12a by joint means 124 such as holding with a band, sealing with a sealing material and screwing, or adhering with an adhesive.

A blow-by gas supplied to the returning hose 12 from the blow-by gas passage 121a of the pressure regulation portion 121 and intake air from the intake pipe 13 are mixed in the blow-by gas mixed joint 20D. The blow-by gas mixed joint 20D has a three-way joint structure, and has a blow-by gas inlet provided in an intake passage communicating with the pipe conduit of the intake pipe 13. The blow-by gas inlet is connected to the other end of the returning hose 12. The blow-by gas mixed joint 20D is provided with a temperature sensor 14 so that an intake air temperature in the intake passage of the blow-by gas mixed joint 20D is detected.

In the pressure regulation portion 121 provided in the diesel engine 1 of the fifth embodiment as described above, the blow-by gas passage 121a via which a blow-by gas discharged from the exhaust gas outlet 11 that is a blow-by gas outlet of the engine body is caused to flow to the returning hose 12 has a pressure regulation hole 121b communicable with the outside. In FIG. 11, the pressure regulation hole 121b is provided above the blow-by gas passage 121a, so that an upper end of the blow-by gas passage 121a is opened. The pressure regulation portion 121 is provided with a pressure regulation valve 122 that closes the upper end opening of the pressure regulation hole 121b in a normal state. In the diesel engine 1 of the fifth embodiment, a plate spring that starts bending when subjected to a predetermined pressure is used as the pressure regulation valve 122. The predetermined pressure in the fifth embodiment is equal to or greater than 5 kPa and equal to or less than 8 kPa, and is set at 5 kPa, for example.

The pressure regulation valve 122 in the fifth embodiment is configured such that, in a normal state where the pressure in the blow-by gas passage 121a is equal to or less than the predetermined pressure, the upper end opening of the pressure regulation hole 121b is air-tightly closed by the pressure regulation valve 122 that is the plate spring. In the example of the configuration of the fifth embodiment, the plate spring is used as the pressure regulation valve 122 and the screw is used as fixing means 123. However, the present disclosure is not limited to such a configuration, and may be any configuration in which the blow-by gas passage 121a is opened when the pressure in the blow-by gas passage 121a exceeds the predetermined pressure.

The following will explain operation of the pressure regulation portion 121 in the diesel engine 1 according to the fifth embodiment having the configuration described above.

As described above, in the configuration of the fifth embodiment, a supercharger 7 (see FIG. 10) is provided downstream of the blow-by gas mixed joint 20D connected to the intake pipe 13 in which intake air flows. Thus, the inside of the blow-by gas passage 121a of the pressure regulation portion 121 connected to the blow-by gas mixed joint 20D via the returning hose 12 is at a negative pressure. Accordingly, a blow-by gas discharged from the exhaust gas outlet 11 of the engine body is caused to flow to the blow-by gas mixed joint 20D through the blow-by gas passage 121a of the pressure regulation portion 121 and the returning hose 12.

In the normal state where the blow-by gas flows in the above-described manner, the blow-by gas from the exhaust gas outlet 11 of the engine body flows through the pressure regulation portion 121 and the returning hose 12 to be introduced into the blow-by gas mixed joint 20D, so that the blow-by gas and the intake air are mixed and sucked to the supercharger 7. In the pressure regulation portion 121 in such a normal state, the blow-by gas passage 121a is at a negative pressure, and thus the plate spring that is the pressure regulation valve 122 is not operated.

For example, in a case where the diesel engine 1 of the fifth embodiment is used as a power source in arctic regions (e.g., at an outdoor temperature of −20° C.), there occurs a phenomenon that, when a blow-by gas and intake air are mixed in the blow-by gas mixed joint 20D, moisture contained in the blow-by gas is instantly frozen by the intake air (e.g., at an intake air temperature of −20° C.) to generate ice coating on the wall of a pipe conduit near a mixed region where the blow-by gas and the intake air are mixed. If the ice coating on the wall blocks the pipe conduit, internal pressures in components such as the returning hose 12 that is the pipe conduit for the blow-by gas, the blow-by gas passage 121a of the pressure regulation portion 121, and the crank case of the engine body, each of which is upstream of the blocked position, are increased. In this case, if the internal pressure in the blow-by gas passage 121a of the pressure regulation portion 121 reaches the predetermined pressure (e.g., 5 kPa), the plate spring that is the pressure regulation valve 122 starts bending, so that the upper end opening of the pressure regulation hole 121b is opened. Consequently, the blow-by gas in the blow-by gas passage 121a of the pressure regulation portion 121 is discharged to the outside, so that the internal pressure in the crank case is decreased. Therefore, it is possible to ensure prevention of a trouble that the pressure in the crank case is increased abnormally and engine oil in the crank case is leaked out therefrom.

As described above, for example, even in the case where the pipe conduit near the mixed region where the blow-by gas and the intake air are mixed is blocked with ice, the plate spring that is the pressure regulation valve 122 in the pressure regulation portion 121 operates to perform pressure regulation, so that the pressure in the pipe conduit for the blow-by gas upstream of the blocked pipe conduit is not increased and the pressure in the crank case is maintained at equal to or less than the predetermined pressure. When the pipe conduit having been blocked with ice is opened due to rise of the ambient temperature and/or a heating process on the frozen part, the pressure in the pipe conduit becomes equal to or less than the predetermined pressure. Consequently, the plate spring that is the pressure regulation valve 122 of the pressure regulation portion 121 returns to the normal state, and the upper end opening of the pressure regulation hole 121b is returned to the air-tightly closed state.

In the configuration of the fifth embodiment described above, the pressure regulation portion 121 is directly connected to the exhaust gas outlet 11 of the engine body, and the pressure regulation valve 122 of the pressure regulation portion 121 is disposed near the exhaust gas outlet 11 of the engine body. In the passage via which a blow-by gas flows from the engine body (valve arm chamber) to the blow-by gas mixed joint 20D, the pressure regulation portion 121 is preferably disposed at a position in which the temperature of the blow-by gas is high and moisture in the blow-by gas is not frozen even if an outdoor temperature is low, i.e., a position as close as possible to the valve arm chamber of the engine body.

As described above, with the diesel engine 1 of according to the fifth embodiment of the present disclosure, it is possible to provide an engine device with high reliability and high safety that overcomes problems caused by a blow-by gas having leaked from a combustion chamber and does not allow lubricating oil in a crank case to leak out therefrom, even in a case where the engine device is used in cold regions, especially in arctic regions at −20° C. or less. The engine device of the fifth embodiment can be an engine device with high reliability and high safety in which the pressure in a crank case is maintained at a predetermined pressure and lubricating oil in the crank case is not leaked out therefrom, even if a pipe conduit in a mixed region where a blow-by gas having leaked from a combustion chamber and intake air (outdoor air) are mixed is blocked with ice coating in use in cold regions, especially in arctic regions at −20° C. or less.

### Sixth Embodiment

Next, a diesel engine serving as an engine device according to a sixth embodiment of the present disclosure will be described mainly with respect to aspects different from the first and fifth embodiments described above. The diesel engine of the sixth embodiment is different from that of the fifth embodiment in the configuration of the pressure regulation portion, and the other part of the configuration is the same as those of the first and fifth embodiments. Thus, in the description of the sixth embodiment, components having the same functions, configurations, and advantages as those in the first and fifth embodiments are denoted by the same reference characters, and detailed description thereof will not be repeated.

FIG. 13 is a cross-sectional view of a pressure regulation portion 125 in a diesel engine 1 according to the sixth embodiment of the present disclosure taken along a flow direction of a blow-by gas. FIG. 14 is a cross-sectional view of the pressure regulation portion 125 taken along line XIV-XIV in FIG. 13.

As illustrated in FIGS. 13 and 14, the pressure regulation portion 125 has a blow-by gas passage 125a that is a pipe conduit via which a blow-by gas discharged from an exhaust gas outlet 11 of the engine body is caused to flow to a returning hose 12. That is, one end of the blow-by gas passage 125a included in the pressure regulation portion 125 of the sixth embodiment is connected to the exhaust gas outlet 11 of the engine body, and the other end of the blow-by gas passage 125a is connected to a returning hose joint 12a provided in one end of the returning hose 12. In the configuration of the sixth embodiment, the pressure regulation portion 125 is jointed to each of the exhaust gas outlet 11 of the engine body and an end of the returning hose joint 12a by joint means 124 such as holding with a band, sealing with a sealing material and screwing, or adhering with an adhesive.

A blow-by gas supplied to the returning hose 12 from the blow-by gas passage 125a of the pressure regulation portion 125 and intake air from an intake pipe 13 are mixed in a blow-by gas mixed joint 20D (see FIG. 10).

As described above, the pressure regulation portion 125 provided in the diesel engine 1 of the sixth embodiment is provided with the blow-by gas passage 125a via which a blow-by gas discharged from the exhaust gas outlet 11 that is a blow-by gas outlet of the engine body is caused to flow to the returning hose 12. Under the blow-by gas passage 125a, an accumulation portion 125c, which is a space, is provided. The bottom surface of the accumulation portion 125c has a pressure regulation hole 125b communicable with the outside. That is, the pressure regulation hole 125b is provided below the blow-by gas passage 125a, so that a lower end of the pressure regulation hole 125b is opened. The pressure regulation portion 125 is provided with a pressure regulation valve 126 that closes the lower end opening of the pressure regulation hole 125b in a normal state. In the diesel engine 1 of the sixth embodiment, a plate spring that starts bending when subjected to a predetermined pressure is used as the pressure regulation valve 126. The predetermined pressure in the sixth embodiment is equal to or greater than 5 kPa and equal to or less than 8 kPa, and is set at 5 kPa, for example.

The pressure regulation valve 126 of the sixth embodiment is configured such that, in a normal state where the pressure in the blow-by gas passage 125a is equal to or less than the predetermined pressure, the lower end opening of the pressure regulation hole 125b is air-tightly closed by the pressure regulation valve 126 that is the plate spring. In the example of the configuration of the sixth embodiment, the plate spring is used as the pressure regulation valve 126 and the screw is used as fixing means 127. However, the present disclosure is not limited to such a configuration, and may be any configuration in which the blow-by gas passage 125a is opened when the pressure in the blow-by gas passage 125a exceeds the predetermined pressure.

The following will explain operation of the pressure regulation portion 125 in the diesel engine 1 according to the sixth embodiment having the configuration described above.

Similarly to the configuration of the fifth embodiment described above, the inside of the blow-by gas passage 125a of the pressure regulation portion 125 of the sixth embodiment is at a negative pressure. Accordingly, a blow-by gas from the exhaust gas outlet 11 of the engine body is caused to flow to the blow-by gas mixed joint 20D through the blow-by gas passage 125a of the pressure regulation portion 125 and the returning hose 12.

In the normal state where the blow-by gas flows in the above-described manner, the blow-by gas discharged from the exhaust gas outlet 11 of the engine body flows through the pressure regulation portion 125 and the returning hose 12 to be introduced into the blow-by gas mixed joint 20D, so that the blow-by gas and the intake air are mixed and sucked to a supercharger 7 (see FIG. 10). In the pressure regulation portion 125 in the normal state where the blow-by gas flows in this manner, the blow-by gas passage 125a is at a negative pressure, and thus the plate spring that is the pressure regulation valve 126 is not operated.

For example, in a case where the diesel engine 1 of the sixth embodiment is used as a power source in arctic regions (e.g., at an outdoor temperature of −20° C.), there occurs a phenomenon that, when a blow-by gas and intake air are mixed in the blow-by gas mixed joint 20D, moisture contained in the blow-by gas is instantly frozen by the intake air (e.g., at an intake air temperature of −20° C.) to generate ice coating on the wall of a pipe conduit near a mixed region where the blow-by gas and the intake air are mixed. If the ice coating on the wall blocks the pipe conduit, internal pressures in components such as the returning hose 12 that is the pipe conduit for the blow-by gas, the blow-by gas passage 125a of the pressure regulation portion 125, and the crank case of the engine body, each of which is upstream of the blocked position, are increased. In this case, if the internal pressure in the blow-by gas passage 125a of the pressure regulation portion 125 reaches the predetermined pressure (e.g., 5 kPa), the plate spring that is the pressure regulation valve 126 starts bending, so that the lower end opening of the pressure regulation hole 125b is opened. Consequently, the blow-by gas in the blow-by gas passage 125a of the pressure regulation portion 125 is discharged to the outside, so that the internal pressure in the crank case is decreased. Therefore, with the configuration of the sixth embodiment, it is possible to ensure prevention of a trouble that the pressure in the crank case is increased abnormally and engine oil in the crank case is leaked out therefrom.

In addition, in the configuration of the sixth embodiment, the pressure regulation portion 125 includes the accumulation portion 125c under the blow-by gas passage 125a. The blow-by gas discharged from the exhaust gas outlet 11 of the engine body contains moisture. The blow-by gas discharged from the exhaust gas outlet 11 of the engine body is rapidly cooled in the pressure regulation portion 125 especially when the outdoor temperature is low. Consequently, the moisture in the blow-by gas is liquefied in the pressure regulation portion 125, and water resulting from the liquefaction is accumulated in the accumulation portion 125c under the blow-by gas passage 125a.

In the accumulation portion 125c, the plate spring that is the pressure regulation valve 126 bends under the weight of the accumulated water, so that the lower end opening of the pressure regulation hole 125b is opened. Consequently, the water in the accumulation portion 125c is discharged. Thus, in the configuration of the sixth embodiment, for example, if the pipe conduit in which a blow-by gas flows is blocked with ice, a pipe conduit for a blow-by gas located upstream of the blocked position is opened and the amount of moisture in the blow-by gas to be mixed with intake air is reduced. This reduces the amount and rate of generation of ice when the blow-by gas and the intake air are mixed, thereby reducing the possibility that the pipe conduit near the mixed region where the blow-by gas and the intake air are mixed is blocked with ice.

As described above, for example, even in the case where the pipe conduit near the mixed region where the blow-by gas and the intake air are mixed is blocked with ice, the plate spring that is the pressure regulation valve 126 in the pressure regulation portion 125 operates to perform pressure regulation, so that the pressure in the pipe conduit for the blow-by gas located upstream of the blocked pipe conduit is not increased and the pressure in the crank case is maintained at equal to or less than the predetermined pressure. When the pipe conduit having been blocked with ice is opened due to rise of the ambient temperature and/or a heating process on the frozen part, the pressure in the pipe conduit becomes equal to or less than the predetermined pressure. Thus, the plate spring that is the pressure regulation valve 126 of the pressure regulation portion 125 is returned to the state where the lower end opening of the pressure regulation hole 125b is air-tightly closed.

In the configuration of the sixth embodiment described above, the pressure regulation portion 125 is directly connected to the exhaust gas outlet 11 of the engine body, and the pressure regulation valve 126 of the pressure regulation portion 125 is disposed near the exhaust gas outlet 11 of the engine body. In the passage via which a blow-by gas flows from the engine body (valve arm chamber) to the blow-by gas mixed joint 20D, the pressure regulation portion 125 is preferably disposed at a position in which the temperature of the blow-by gas is high and moisture in the blow-by gas is not frozen even if an outdoor temperature is low, i.e., a position as close as possible to the valve arm chamber of the engine body.

As described above, the engine device according to the sixth embodiment of the present disclosure can be an engine device with high reliability and high safety that can reduce a phenomenon in which a pipe conduit near a mixed region where a blow-by gas having leaked from a combustion chamber and intake air (outdoor air) are mixed is blocked with ice, and that can maintain the pressure in a crank case at a predetermined pressure and does not allow lubricating oil in the crank case to leak out therefrom, even in a case where the engine device is used in cold regions, especially in arctic regions at −20° C. or less.

### Seventh Embodiment

Next, a diesel engine serving as an engine device according to a seventh embodiment of the present disclosure will be described mainly with respect to aspects different from the first and fifth embodiments described above. The diesel engine of the seventh embodiment is different from that of the fifth embodiment in the configuration of the returning hose via which a blow-by gas from the engine body to the blow-by gas mixed joint flows, and the other part of the configuration is the same as those of the first and fifth embodiments. Thus, in the description of the seventh embodiment, components having the same functions, configurations, and advantages as those in the first and fifth embodiments are denoted by the same reference characters, and detailed description thereof will not be repeated.

FIG. 15 is a view schematically illustrating arrangement of a returning hose via which a blow-by gas from an exhaust gas outlet of an engine body to a blow-by gas mixed joint flows in a diesel engine 1 according to the seventh embodiment of the present disclosure. FIG. 16 is a view schematically illustrating a configuration of the returning hose in the diesel engine 1 according to the seventh embodiment.

As illustrated in FIG. 15, a returning hose 130 in the diesel engine 1 of the seventh embodiment includes an upstream-side returning hose 112A disposed toward the bottom so as to flow a blow-by gas downward from an exhaust gas outlet 11 (see FIG. 10) of the engine body and a downstream-side returning hose 112B configured to flow the blow-by gas to a blow-by gas mixed joint 20D (see FIG. 10) through an intermediate connection portion 129 for the returning hose. That is, in the returning hose 130, the intermediate connection portion 129 for the returning hose is located in an undermost position, and the upstream-side returning hose 112A and the downstream-side returning hose 112B are extended upward from the intermediate connection portion 129 for the returning hose. In addition, a discharge pipe 132 directed to an oil pan from the intermediate connection portion 129 for the returning hose is provided. In the configuration of the seventh embodiment, the intermediate connection portion 129 for the returning hose has the functions of the pressure regulation portions in the above-described fifth and sixth embodiments.

As illustrated in FIG. 16, the intermediate connection portion 129 for the returning hose has a blow-by gas passage 128 having a substantially U-shape. The blow-by gas passage 128 has ends that are respectively connected to the upstream-side returning hose 112A and the downstream-side returning hose 112B. An undermost part of the blow-by gas passage 128 has an opening, and a pressure regulation valve 131 such as a plate spring is provided to cover the opening. The pressure regulation valve 131 that is a pressure regulation portion in the seventh embodiment has the same function as those of the pressure regulation valves (122, 126) of the pressure regulation portions (121, 125) in the above-described embodiments, and operates to cause an internal space of the returning hose to be communicated with the outside when the pressure in the returning hose in which a blow-by gas from the engine body flows becomes a pressure greater than a preset pressure (e.g., a pressure equal to or greater than 5 kPa).

In the intermediate connection portion 129 for the returning hose, a blow-by gas directed from the engine body to the blow-by gas mixed joint 20D flows in the blow-by gas passage 128 having a substantially U-shape. Therefore, a lower part of the blow-by gas passage 128 has an accumulation portion 128a in which moisture contained in the blow-by gas is accumulated. A pressure regulation valve 131 is disposed in the bottom surface of the accumulation portion 128a. The plate spring that is the pressure regulation valve 131 bends under the weight of the water accumulated in the accumulation portion 128a, so that the opening in the undermost part of the blow-by gas passage 128 is opened. Consequently, the water accumulated in the accumulation portion 128a is discharged from the discharge pipe 132 communicated with the opening to an oil pan located in a lower part of the diesel engine 1.

As described above, the engine device according to the seventh embodiment of the present disclosure can be an engine device with high reliability and high safety that can reduce a phenomenon in which a pipe conduit near a mixed region where a blow-by gas having leaked from a combustion chamber and intake air (outdoor air) are mixed is blocked with ice, and that can maintain the pressure in a crank case at a predetermined pressure and does not allow lubricating oil in the crank case to leak out therefrom even if the pipe conduit is blocked with ice, even in a case where the engine device is used in cold regions, especially in arctic regions at −20° C. or less.

As described above, an engine device according to an aspect of the present disclosure includes a blow-by gas returning mechanism that returns a blow-by gas in an engine body having leaked from a combustion chamber to an intake system, and the blow-by gas returning mechanism includes, for heating, a recirculation path for coolant water that is disposed in a pipe conduit near a mixed region where intake air is merged with a blow-by gas. In this manner, the use of the recirculation path for coolant water in the blow-by gas returning mechanism can reduce a phenomenon in which moisture contained in a blow-by gas is frozen to generate ice coating on the pipe conduit in the blow-by gas returning mechanism, and thus can prevent the pipe conduit from being blocked with ice, even in a case where the engine device according to the aspect of the present disclosure is used as a power source in a cold region or an arctic region, for example.

In addition, an engine device according to an aspect of the present disclosure includes a blow-by gas returning mechanism that returns a blow-by gas in a crank case having leaked from a combustion chamber to an intake system, and the blow-by gas returning mechanism includes a pressure regulation mechanism. In this manner, the use of the pressure regulation mechanism in the blow-by gas returning mechanism can provide an engine device with high reliability and high safety that can maintain the pressure in the engine body at a predetermined pressure and does not allow lubricating oil to leak out therefrom even if moisture contained in a blow-by gas is frozen to generate ice coating and block a pipe conduit in a blow-by gas mixed joint, even in a case where the engine device according to the aspect of the present disclosure is used as a power source in a cold region or an arctic region, for example.

Any two or more of the configurations described in the foregoing embodiments may be combined as appropriate so that advantages of these configurations can be obtained.

Preferred embodiments of the disclosure are thus sufficiently described with reference to attached drawings. However, it is obvious for a person with ordinary skill in the art to which the present invention pertains that various modifications and changes are possible. Such modifications and changes, unless they depart from the scope of the present disclosure as set forth in claims attached hereto, shall be understood as to be encompassed by the present disclosure.

### INDUSTRIAL AVAILABILITY

The present disclosure is applicable to an engine device such as a diesel engine that is mounted as a power source in various types of power equipment such as a working vehicle, an agricultural machine, an electric generator, and a refrigerator, and is especially useful for an engine device that is used in cold regions and arctic regions.

### REFERENCE SIGNS LIST

1 diesel engine (engine device)

10 head cover

11 exhaust gas outlet of blow-by gas expansion chamber

12 returning hose

13 intake pipe

14 temperature sensor

20, 20A, 20B, 20C, 20D blow-by gas mixed joint

20a intake passage

20b blow-by gas inlet

20c sensor holding part

21, 22 heating portion

21a, 22a coolant water inlet

21b, 22b coolant water outlet

23 coolant water pipe conduit

24 blow-by gas introduction pipe

25 spacer

26 coolant water pipe

121, 125 pressure regulation portion

1. An engine device having a blow-by gas returning mechanism that returns a blow-by gas having leaked from a combustion chamber to an intake pipe in which intake air flows, the engine device comprising:
a returning hose in which the blow-by gas from the combustion chamber flows;
a blow-by gas mixed joint configured to introduce the blow-by gas flowing in the returning hose into the intake pipe; and
a heating portion configured to increase a temperature in a mixed region where intake air flowing in the blow-by gas mixed joint and the blow-by gas introduced from the returning hose are mixed, wherein
the heating portion is provided in a recirculation path of engine coolant in the engine device, uses the engine coolant as a heating source, and is configured to allow the engine coolant to flow through an inside of the heating portion, and
the heating portion is in close contact with and surrounds a part of an outer peripheral surface of the blow-by gas mixed joint, the part corresponding to the mixed region where intake air flowing in an intake passage of the blow-by gas mixed joint and the blow-by gas introduced from the returning hose into the intake passage of the blow-by gas mixed joint are mixed.

2. (canceled)

3. The engine device according to claim 1, wherein the heating portion is configured to allow coolant water to flow in a part of an outer peripheral surface of the blow-by gas mixed joint, the part being an upstream of a region of the blow-by gas mixed joint into which the blow-by gas is introduced from the returning hose.

4. The engine device according to claim 1, wherein the heating portion is configured to allow coolant water to flow in parts of an outer peripheral surface of the blow-by gas mixed joint, the parts being an upstream and a downstream of a region of the blow-by gas mixed joint into which the blow-by gas is introduced from the returning hose.

5. (canceled)

6. (canceled)

7. (canceled)

8. The engine device according to claim 1, further comprising
a pressure regulation portion including a blow-by gas passage in which the blow-by gas from the combustion chamber flows, wherein
the returning hose is connected to the blow-by gas passage; and
the pressure regulation portion includes a pressure regulation valve configured to cause the blow-by gas passage to be communicated with an outside when a pressure in the blow-by gas passage exceeds a predetermined pressure.

9. The engine device according to claim 8, wherein the pressure regulation portion includes an accumulation portion under the blow-by gas passage, and the accumulation portion is configured such that liquid contained in the blow-by gas flowing through the blow-by gas passage is accumulated in the accumulation portion.

10. The engine device according to claim 9, wherein the pressure regulation valve is configured to open an opening in a bottom surface of the accumulation portion under a weight of the liquid accumulated in the accumulation portion.

11. The engine device according to claim 8, wherein the returning hose is connected to the blow-by gas mixed joint such that the blow-by gas is introduced from below.

12. The engine device according to claim 11, wherein the pressure regulation portion is located in an undermost position of a path via which the blow-by gas is caused to flow from the combustion chamber to the blow-by gas mixed joint so that a liquid contained in the blow-by gas is discharged.

13. The engine device according to claim 1, wherein the blow-by gas mixed joint is provided with a temperature sensor so that an intake air temperature in the intake passage is detected.
